(19) United States
(12) Patent Application Publication
(10) Pub. No.: US 2002/0065342 A1
(43) Pub. Date: May 30, 2002

(54) Polypropylene resin composition for metallized film and metallized film prepared therefrom

(76) Inventors: Shigeki Kishiro, Ichihara-shi (JP); Yoshiaki Oobayashi, Ichihara-shi (JP)

Correspondence Address: BIRCH STEWART KOLASCH & BIRCH, PO BOX 747, FALLS CHURCH, VA, 22040-0747, US

(21) Appl. No.: 09/974,050

(22) Filed: Oct. 11, 2001

(30) Foreign Application Priority Data
Oct. 13, 2000 (JP) 2000-313499

(51) Int. Cl. C08K 5/49

(52) U.S. Cl. 524/117

(57) ABSTRACT

A polypropylene resin composition for a film for metallization, which comprises 100 parts by weight of a polypropylene resin and 0.01 to 1 part by weight of a phosphite represented by the general formula (I):

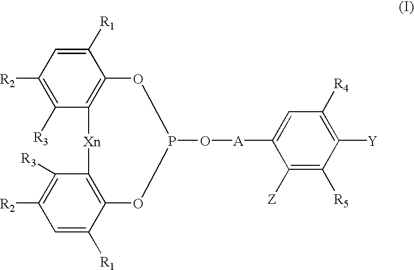

(wherein, R¹, R², R⁴ and R⁵ represent individually hydrogen, an alkyl, cycloalkyl, alkylcycloalkyl, aralkyl or phenyl; R³ represents hydrogen or an alkyl; X represents sulfur atom or a —CHR⁶— group (R⁶ represents hydrogen, an alkyl or cycloalkyl); n is 0 or 1; A is an alkylene or a *—CO(R⁷)ₘ— group (R⁷is an alkylene, * mark is indicative of the bonding site of A to oxygen and m is 0 or 1); and either one of Y or Z is hydroxy, alkoxy or aralkyloxy and the other is hydrogen or an alkyl.), a film thereof, and a metallized film thereof.

### BACKGROUND OF THE INVENTION

1. Field of the Invention

The present invention relates to a polypropylene resin composition for a metallized film, a film for metallization made thereof and a metallized film prepared therefrom. Particularly, the present invention relates to a polypropylene resin composition which provides a film excellent in adoptability of metallization, odorless, and not deteriorating taste of the foodstuff packed in a package made of the metallized film, to a polypropylene resin composition film thereof for metallization and to a metallized polypropylene resin composition film prepared therefrom.

2. Description of Related Art

A polypropylene film has excellent transparency, mechanical strength and heat resistance and has been used for a packaging material due to such suitable properties, and an additive such as an antioxidant is added thereto for use of a packaging film. And, the polypropylene film is subjected to deposition of metallic material such as aluminum in order to give a gas barrier property or light screening property, and used as a metallized film, further, subjected to printing thereon, and laminated with other film(s) for practical use. It happens, however, that the wetting tension of the surface on which metallic material has been metallized is lowered during the storage period causing problems in the subsequent process of printing or lamination after a period of storage. Thus, a polypropylene film with an excellent adaptability for aluminum metallization has been developed.

In JP59-011249A, for example, it is disclosed that a film is made of a resin composition containing 0.1 to 0.2 parts by weight of an antioxidant with a melting point higher than 80° C. and 0.01 to 0.5 parts by weight of an anti-blocking agent are added to a polypropylene resin and that an aluminum metallization film is obtained where the soluble fraction of the film in a cold xylene is less than 5% by weight. It happened, however, that the film for aluminum metallization is insufficient in processing stability and generates unpleasant odor, and further tastes of some foodstuff which have contacted with the film is deteriorated. Additionally, in a case of use for printing on the film for aluminum metallization or laminating another film therewith, problems with respect to the printing or the lamination with other film(s) during storage sometimes occurred.

### SUMMARY OF THE INVENTION

An object of the present invention is to provide a polypropylene resin composition film for metallization having an excellent adaptability for metallization and little odor and further not deteriorating the taste.

Namely, the present invention relates to a polypropylene resin composition for a film for metallization, comprising 100 parts by weight of a polypropylene resin and 0.01 to 1 part by weight of a phosphite represented by the general formula (I) to 100 parts by weight of the polypropylene resin.

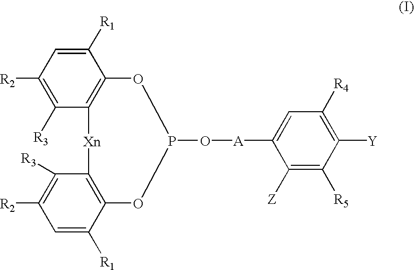

(wherein R¹, R², R⁴ and R⁵ individually represent a hydrogen atom, alkyl group having 1 to 8 carbon atoms, cycloalkyl group having 5 to 8 carbon atoms, alkylcycloalkyl group having 6 to 12 carbon atoms, aralkyl having 7 to 12 carbon atoms or phenyl group, respectively; R³ represents a hydrogen atom or alkyl group having 1 to 8 carbon atoms; X represents a sulfur atom or —CHR⁶— group (R⁶ is a hydrogen atom, alkyl group having 1 to 8 carbon atoms or a cycloalkyl group having 5 to 8 carbon atoms); n is 0 or 1; A represents an alkylene group having 2 to 8 carbon atoms or a *—CO(R⁷)ₘ— group (R⁷ is an alkylene group having 1 to 8 carbon atoms, * mark is indicative of the bonding site of A to oxygen atom, and m is 0 or 1.); and either one of Y or Z is a hydroxy group, alkoxy group having 1 to 8 carbon atoms, or aralkyloxy group having 7 to 12 carbon atoms and the other is a hydrogen atom or alkyl group having 1 to 8 carbon atoms.), a polypropylene resin composition film for decomposition made thereof, and a metallized polypropylene resin composition film.

The present invention will be described in more detail below.

### DETAILED DESCRIPTION OF THE INVENTION

The polypropylene resin used in the present invention is a homopolymer or copolymer obtained by polymerization of propylene or monomers containing mainly propylene. The polypropylene resin includes, for example, a propylene homopolymer, propylene-ethylene random copolymer, propylene-α-olefin having 4 to 12 carbon atoms random copolymer, propylene-ethylene-α-olefin having 4 to 12 carbon atoms random ternary copolymer, polypropylene copolymer (sometimes called as a propylene-ethylene block copolymer) composed of a polymer component obtained by polymerizing mainly propylene in a first step and a copolymer component obtained by subsequently copolymerizing propylene and ethylene and/or the α-olefin in a second or later steps. Among them, a propylene homopolymer, propylene-ethylene random copolymer, propylene-α-olefin random copolymer, propylene-ethylene-α-olefin three elements copolymer are preferable. The polymers may be used alone or in combination of two or more of the propylene polymers.

The α-olefin includes α-olefins having 4 to 12 carbon atoms, and specific examples thereof include, for example, 1-butene, 2-methyl-1-propylene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethy-1-butene, 1-heptene, methyl-substituted-1-hexenes, dimethyl-substituted-1-pentenes, 1-octene, methyl-substituted-1-pentenes, ethyl-substituted-1-hexenes, dimethyl substituted-1-hexenes, propyl substituted-1-heptenes, methyl, ethyl-substituted-1-heptenes, trimethyl-subustituted-1-pentenes, propyl-substituted-1-pentenes, diethyl-substituted-1-butenes, 1-nonene, 1-decene, 1-undecene, 1-dodecene. Among the α-olefins, 1-butene, 1-pentene, 1-hexene and 1-octene are preferable and still more preferable are 1-butene and 1-hexene from the viewpoints of copolymerization characteristics and production cost.

The content of the unit derived from ethylene and/or α-olefin having 4 to 12 carbon atoms in the copolymer is not particularly limited, but, it is usually from 0.1 to 20% by weight and preferably from 0.1 to 10% by weight. Herein, when ethylene and the α-olefin were used, the content means a total content of ethylene and the α-olefin.

From the viewpoint of adaptability to metallization, the amount of 20° C. -xylene soluble fraction of the polypropylene resin used is preferably less than 7% by weight, and more preferably less than 5% by weight.

The method of producing the polypropylene resin used in the present invention is not particularly limited, and the polypropylene resin is produced by a known method using a known catalyst.

As a known catalyst, for example, there are used a Ti-Mg catalyst system comprising a solid catalyst component which is a magnesium compound combined with Ti compound, a catalyst system composed of the aforementioned solid catalyst component, an organoaluminum compound and optionally an electron donor as a third component, and a metallocene catalyst system. A catalyst system obtained by combining a solid catalyst component containing Mg, Ti and a halogen as essential components, an organoaluminum compound and an electron donor, is preferable. The preferable catalyst systems are described in JP61-218606A, JP61-28790A, JP07-216017A and the like.

As a method of polymerization, for example, slurry polymerization using an inert hydrocarbon solvent, solution polymerization, bulk polymerization without a solvent, and gas phase polymerization or a liquid phase-gas phase polymerization in which the liquid phase and a vapor phase polymerizations are carried out sequentially. The gas phase polymerization is preferable.

In the production of polypropylene used in the present invention, the propylene may be dried at a temperature lower than that at which the polypropylene is melted, to remove a residual solvent and a oligomer having an ultra low molecular weight as a by-product and the like. Such methods of drying are described, for example, in JP550755410 A and JP2565753B2.

The melt flow rate (MFR) of the polypropylene used in the present invention is not particularly restricted. It is, however, that MFR is preferably within a rage from 0.1 to 50 g/10 min., and more preferably from 1 to 20 g/10 min., from the viewpoint of fluidity and film forming property.

The phosphate used in the present invention is represented by the following general formula (I):

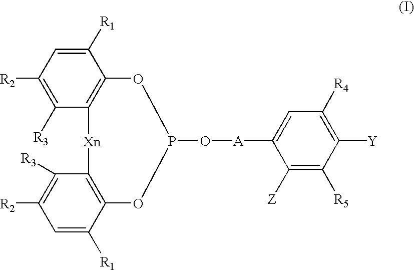

(wherein R¹, R², R⁴ and R⁵ individually represent a hydrogen atom, alkyl group having 1 to 8 carbon atoms, cycloalkyl group having 5 to 8 carbon atoms, alkylcycloalkyl group having 6 to 12 carbon atoms, aralkyl having 7 to 12 carbon atoms or phenyl group, respectively; R³ represents a hydrogen atom or alkyl group having 1 to 8 carbon atoms; X represents a sulfur atom or —CHR⁶— group (R⁶is a hydrogen atom, alkyl group having 1 to 8 carbon atoms or a cycloalkyl group having 5 to 8 carbon atoms); n is 0 or 1; A represents an alkylene group having 2 to 8 carbon atoms or *—CO(R⁷)ₘ— group (R⁷ is an alkylene group having 1 to 8 carbon atoms, * mark is indicative of the bonding site of A to oxygen atom, and m is 0 or 1.); and either one of Y or Z is a hydroxy group, alkoxy group having 1 to 8 carbon atoms, or aralkyloxy group having 7 to 12 carbon atoms and the other is a hydrogen atom or alkyl group having 1 to 8 carbon atoms.)

In the phosphite represented by the formula (I), the respective groups R¹, R², R⁴ and R⁵ are independently a hydrogen atom, an alkyl group having 6 to 12 carbon atoms, a cycloalkyl group having 6 to 12 carbon atoms and an aralkyl having 7 to 12 carbon atoms or a phenyl group, respectively. The groups R¹, R², and R⁴ are preferably an alkyl group having 1 to 8 carbon atoms, a cycloalkyl group having 5 to 8 carbon atoms, alkykcycloalkyl group having 6 to 12 carbon atoms and R⁵ is a hydrogen atom, an alkyl group having 1 to 8 carbon atoms and a cycloalkyl group having 6 to 12 carbon atoms, preferably. Typical examples of the alkyl group having 1 to 8 carbon atoms include, for example, a methyl group, ethyl group, n-propyl group, i-propyl group, n-butyl group, i-butyl group, sec-butyl group, t-butyl group, t-pentyl group, i-octyl group, t-octyl group, 2-ethylhexyl group and the like. Typical examples of the cycloalkyl group having 5 to 8 carbon atoms include, for example, a cyclopentyl group, cyclohexyl group, cycloheptyl group, cyclooctyl group and the like, and further typical examples of the alkylcycloalkyl group having 6 to 12 carbon atoms include, for example, 1-methylcyclopentyl group, 1-methylcyclohexyl group, 1-methyl-4-i-propylcyclohexyl group. Typical examples of aralkyl group having 7 to 12 carbon atoms include, for example, benzyl group, α-methylbenzyl group, α, α-dimethylbenzyl group.

Among these, R¹ and R⁴ are preferably t-alkyl groups such as t-butyl group and t-octyl group, cyclohexyl group and 1-methylcyclohexyl group, respectively. R² is preferably an alkyl group having 1 to 5 carbon atoms such as a methyl group, ethyl group, n-propyl group, i-propyl group, n-butyl group, i-butyl group, sec-butyl group, t-butyl group and t-pentyl group. R⁵is preferably a hydrogen atom and an alkyl group having 1 to 5 carbon atoms such as a methyl group, ethyl group, n-propyl group, i-propyl group, n-butyl group, i-butyl group, t-butyl group and t-pentyl group.

R³ represents a hydrogen atom or alkyl group having 1 to 8 carbon atoms. As the alkyl groups having 1 to 8 carbon atoms, for example, the same alkyl groups as previously described are included. R³ is preferably a hydrogen atom or an alkyl group having 1 to 5 carbon atoms, and a hydrogen atom or methyl group is particularly preferred.

X represents that two groups having a phenoxy structure respectively are bonded directly when n is zero, and X represents a sulfur atom or a methylene group with which an alkyl group having 1 to 8 carbon atoms or a cycloalkyl group having 5 to 8 carbon atoms may be substituted when n is 1. Herein, the alkyl group having 1 to 8 carbon atoms and the cycloalkyl group include the same alkyl groups and cycloalkyl groups respectively as described previously. In the substituent X, it is preferable that n is zero, namely the two groups each of which has a phenoxy structure are bonded directly, or that n is 1 and a methylene group or a methylene group substituted with a methyl group, ethyl group, n-propyl group, i-propyl group, n-butyl group, i-butyl group, t-butyl group or the like.

The substituent A represents an alkylene group having 2 to 8 carbon atoms or *—CO(R⁷)ₘ— group (R⁷ represents an alkylene group having 1 to 8 carbon atoms, and *mark indicates a bonding site to oxygen atom and m is 0 or 1.).

Typical examples of the alkylene group having 2 to 8 carbon atoms include, for example, an ethylene group, propylene group, butylene group, pentamethylene group, hexamethylene group, octamethylene group, 2,2-dimethyl-1,3-propylene group. A propylene group is preferably used. Further, *mark in*—CO(R ⁷)ₘ— group indicate that the carbonyl is a bonding site to the oxygen atom of phosphite. Typical examples of the alkylene group having 1 to 8 carbon atoms in the substituent R⁷ include, for example, groups of methylene, ethylene, propylene, butylene, hexamethylene, octomethylene, and 2,2-dimethyl 1,3-propylene. It is preferable that *—CO(R⁷)ₘ— is either *—CO— group in which m is zero or —CO(CH₂CH₂)— group where m is 1 and R⁷ is ethylene.

Either one of X or Y represents a hydroxy group, alkoxy group having 1 to 8 carbon atoms or aralkyloxy group having 7 to 12 carbon atoms, and the other one represents a hydrogen atom or an alkyl group having 1 to 8 carbon atoms. More specifically, the alkyl group having 1 to 8 carbon atoms includes, for example, the same alkyl group as described previously and the alkoxy group includes those alkoxy groups in which their alkyl moieties are the same as the above described alkyl group having 1 to 8 carbon atoms. Further the aralkyloxy group having 7 to 12 carbon atoms includes, for example, those aralkyloxy groups in which their aralkyl moieties are the same as the aralkyl group having 7 to 12 carbon atoms.

The amount of the phosphate (I) used in the present invention is 0.01 to 1.0 part by weight per 100 parts by weight of polypropylene resin, and from the viewpoint of adaptability to metallization, 0.01 to 0.5 parts by weight is preferable and 0.01 to 0.3 parts by weight is more preferable.

When the amount of the phosphite is less than 0.01 part by weight, the odor may generate and the taste of foods packed in a bag prepared from a film of the polypropylene may be deteriorated due to insufficient processing stability. When the amount exceeds 1.0 part by weight, then adaptability to metallization may become worse and this is not economical since the used amount of the phosphite (I) increases.

To the resin composition used in the present invention, other additives or other resins and elastomers may be added. The other additives include, for example, antioxidants, UV absorbers, antistatic agents, lubricating agents, nucleating agents, tackifiers, anti-clouding agents, anti-blocking agents and the like.

Other resins include polyolefin resins or elastomers such as various polyethylenes, polybutenes, ethylene-α-olefin copolymer elastomers. And these resins and elastomers may be ones produced with a heterogeneous olefin polymerization catalyst system or a homogenous olefin polymerization catalyst system represented by a metallocene catalyst system. Furthermore, styrene-based copolymer elastomers produced by hydrogenation of styrene-butadiene-styrene block copolymer or of styrene-isoprene-styrene block copolymer, and the like are also listed.

The method of producing the resin composition includes a known method so far as a homogeneous composition can be obtained. For example, a method of compounding the polypropylene with the phosphite (I), and optionally the other additives and/or the other resin, and then mixing the admixture in a molten state, and the like are illustrated.

As the compounding method, there are illustrated, for example, a method of directly mixing polypropylene resin powder with phosphate (I) and optionally other additives with a mixing apparatus such as a Henschel mixer, a method of mixing a master batch of the polypropylene resin containing the additives of a high concentration, previously prepared with polypropylene resin powder, a method of adding the additives to the polypropylene resin in a molten state.

In addition, the other additives to be optionally added may be mixed with polypropylene resin together with the phosphite (I) or separately.

The apparatus used for melt-kneading is not particularly restricted and publicly known apparatus can be used. Preferably, an extruder, a Banbury mixer, a batch type kneader or the like is used. It is preferable that the melt-kneading is carried out in an inert gas such as nitrogen or argon, and the temperature is lower than 300° C., and preferably from 180° C. to 250° C.

The polypropylene film for metallization of the present invention may be either a single layered film made of the resin composition for metallization or a multi-layered film having alayer made of the resin composition for metallization. In the case of the multi-layered film, other layer(s) is not restricted. It is, however, preferable that the other layer having no odor and not deteriorating the taste of the foodstuff contacting with the film, having a good adaptability to metallization, and not lowering the wetting tension of the surface to be metallized when the film is stored in a wound state.

As a method of producing the polypropylene film for metallization of the present invention, there are listed a method of producing a single layered film by a known process such as a inflation process, T-die process, calendering or the like, and a method of forming a film of the polypropylene resin for metallization film of the present invention as a layer of a multi-layered film, and laminating the film and a film made of another resin, and the like. The methods of manufacturing the multi-layered film include an extrusion lamination method, hot lamination method, dry laminating method and the like which are generally used. Further, the stretched film can be produced by stretching a pre-formed film or sheet. The stretching methods include a uniaxial or biaxial stretching method, for example, a roll stretching method, tenter stretching method, tubular stretching method and the like.

A metallic substance can be deposited on the surface of the polypropylene resin film for metallization of the present invention by, for instance, introducing a metallic vapor into a metallization apparatus where the film is placed under high vacuum. The metallic substance to be deposited includes aluminum, titanium, chromium, nickel, copper, germanium, tin, selenium and the like, and aluminum is preferred. The thickness of metallized aluminum membrane is not limited, but generally from 100 Å to 1000 Å and preferably from 300 Å to 700 Å.

### EXAMPLE

The present invention is explained in more detail by way of the Examples and Comparative Examples, but is not limited thereto.

The methods of preparation of sample specimens used in the Examples and Comparative Examples, and the methods of measurements of properties are described below:

(1) The content of ethylene and 1 -butene unit (unit: weight %) in the polypropylene resin.

The content of ethylene was measured according to the method for random copolymer described in page 616, “Polymer Handbook” (published by Kinokuniya Shoten Co., Ltd. in 1995) based on the IR spectrum measurement.

The content of 1-butene was measured according to the method described in page 619, Polymer Handbook (published by Kinokuniya Shoten Co. ,Ltd. in 1995) based on the IR spectrum measurement.

(2) The 20° C.-xylene soluble fraction in the polypropylene resin(unit: % by weight).

5 g of the polypropylene sample was dissolved in 500 ml of boiling xylene. After the resin sample had been completely dissolved, the solution was cooled to 20° C. and allowed to stand for longer than 4 hours. Then, the precipitates were separated from the solution by filtration, the filtrate was dried at 70° C. under reduced pressure, and the dried solid thus obtained was weighed.

(3) Melt Flow Rate (MFR, unit: g/10 min.) MFR was measured according to JIS K7210 at 230° C. under a load of 21.18N.

(4) Odor Test

Two sheets of film samples of 10.5 cm×12 cm in size were placed in a vessel having an inner volume of 200 ml with a cover of aluminum foil, and sample conditions were adjusted for 2 hours at 60° C. in an air oven. After leaving the film samples for 30 minutes at room temperature, the degree of odor was tested by human organ. The degrees of odor were determined according to the following basis:

◯: almost no smell

Δ: faintly smelled

X: strong odor sensed

(5) Taste Test

6.0 g of rectangular film samples of 100 mm×100 mm in size and 240 ml of mineral water were placed in a vessel of 300 ml and the vessel was covered with a piece of aluminum foil, and the film samples were boiled for 30 minutes. After leaving overnight, 50 ml of water was poured into a cup and was subjected to testing by human organ. The degrees of taste were determined according to the following basis:

◯: almost no taste

Δ: faintly tasted

X: clearly tasted

(6) Adaptability to metallization (wetting tension of aluminum metallization surface, unit: dyne/cm)[Evaluation test (6)]

The film of 18.5 cm×18.5 cm in size was placed over an aluminum metallized surface of PET film of 20 cm×20 cm in size so that the untreated surface of the film faces to the aluminum metallized surface of the PET film, and it was kept under a pressure of 32 g/cm² at 45° C. for 24 hours. After leaving the samples at room temperature for more than 1 hour, the wetting tension of the aluminum metallization surface of the aluminum metallized PET film sample was measured. The wetting tension of the aluminum metallization surface of the PET film sample before testing was more than 54 dyne/cm.

The purpose of this test was to realize the changes of wetting tension of the metallized surface when the polypropylene film for metallization of the present invention was stored in a roll form after the film was subjected to metallization treatment through simulation model. Consequently, it is indicated that the higher the wetting tension, the larger the adaptability to the metallization.

(7) Adaptability to metallization (wetting tension of aluminum metallized surface, unit: dyne/cm) [Evaluation test (7)]

The film of 18.5 cm×18.5 cm in size was placed over an aluminum metallized surface of a film of 20 cm×20 cm in size so that the untreated surface of the film faces to the aluminum metallized surface of the film, and it was kept under a pressure of 32 g/cm at 45° C. for 24 hours. After leaving the samples at room temperature for more than 1 hour, the wetting tension of the aluminum metallized surface of the aluminum metallized film sample was measured. The wetting tension of the aluminum metallized surface of the film sample before testing was more than 54 dyne/cm.

### EXAMPLE 1

To 100 parts by weight of a polypropylene resin (propylene-ethylene-1-butene random copolymer, ethylene unit content: 1.2% by weight, 1-butane unit content: 4.0% by weight, and 20° C.-xylene soluble fraction: 1.3% by weight), 0.05 parts by weight of the phosphate (1) described below, was added and mixed for 3 minutes using a Henschel mixer replaced with nitrogen therein. The mixture was fed to a nitrogen substituted hopper and was melt-kneaded at set temperature of 220° C. using a 40 mm Φ single screw extruder and then was pelletized. MFR was 8.0 g/10 min.

90 parts by weight of the pellet obtained was dry-blended with 7% by weight of MBO6B(polypropylene master batch containing silica fine powder of 2 wt % as an anti-blocking agent, manufactured by Sumitomo Chemical Co., Ltd.) and 3% by weight of G1900(high density polyethylene manufactured by Keiyo Polyethylene Co., Ltd) to obtain a mixture and a film of 30 μm in thickness was prepared by extruding the mixture at a resin temperature of 250° C. and a discharge rate of 12 kg/hr with a 50 mm Φ extruder equipped with a coat-hanger type T-die of 400 mm in width, cooling an extruded film at a chill roll temperature of 50° C. and line velocity of 20 m/min. with an air-chamber type cooling system. One side of the surfaces of the resulting film was subjected to a corona discharge treatment. The results of the evaluation of the film according Evaluation test (6) are shown in Table 1. Phosphite compound (1): 6-[3-(3-t-butyl-4-hydroxy-5-methylphenyl)propoxy]-2,4,8, 10-tetra-t-butylbenz[d,f][1,3,2]dioxaphosphepin (CAS No. 2032555-81-6) (Sumilizer GP, manufactured by Sumitomo Chemical Co., Ltd.)

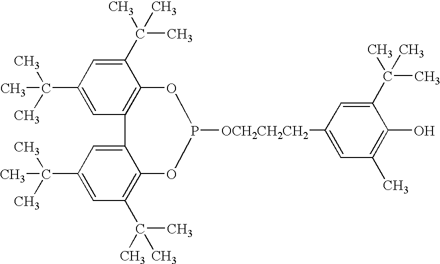

### EXAMPLE 2

Pellet was prepared in the same manner as in Example 1 except that 0.10 part by weight of the phosphite (1) was used. MRF of the pellet was 7.3 g/10 min. A film was prepared in the same manner as in Example 1 except using the pellet, and evaluated. The results of the evaluation of the film according Evaluation test (6) are shown in Table 1.

### Comparative Example 1

Pellet was prepared in the same manner as in Example 1 except that 0.125 part byweight of Irganox 1010 (manufactured by Ciba Specialty Chemicals, Ltd.) was used instead of the phosphite(I). MRF of the pellet was 8.8 g/10 min. A film was prepared in the same manner as in Example 1 except using the pellet, and evaluated. The results of the evaluation of the film according Evaluation test (6) are shown in Table 1.

### Comparative Example 2

Pellet was prepared in the same manner as in Example 1 except that 0.125 part by weight of Irganox 1010 (manufactured by Ciba Specialty Chemicals, Ltd.) and 0.05 parts by weight of Irgafos (manufactured by Ciba Specialty Chemicals, Ltd.) were used instead of the phosphite(I). MRF of the pellet was 7.6 g/10 min. A film was prepared in the same manner as in Example 1 except using the pellet, and evaluated. The results of the evaluation of the film according Evaluation test (6) are shown in Table 1.

TABLE 1

| | | | Wetting tension of |
|---|---|---|---|
| | | | aluminum surface to |
| | | | be metallized |
| | Odor test | Taste test | (dyne/cm) |
| Example 1 | ◯ | ◯ | 45 |
| Example 2 | ◯ | ◯ | 45 |
| Comparative | X | Δ | 41 |
| example 1 | | | |
| Comparative | Δ | X | 41 |
| example 2 | | | |

### EXAMPLE 3

A film was prepared in the same manner as in Example 1. Al metallization was carried out on a corona-treated film surface under conditions of 180A of electric current (ceramic electrode), under a vacuum of 2×10⁻⁵ Torr at an Al feeding rate of 8 scale and winding rate of 10 rpm (2.9 m/minute) using a vacuum metallization apparatus (P-59type manufactured by SATO SHINKU Co,. Ltd.).

The adaptability to metallization of thus obtained metallized film was evaluated according to Evaluation test (7). The wetting tension of the film was 46 dyne/cm.

### EXAMPLE 4

A film was prepared in the same manner as in Example 2. This film was subjected to Al metallization and evaluation in the same manner as in Example 3. The wetting tension of the film was 45 dyne/cm.

### Comparative Example 3

A film was prepared in the same manner as in Comparative Example 1. This film was subjected to Al metallization and evaluation in the same manner as in Example 3. The wetting tension of the film was 41 dyne/cm.

### Comparative Example 4

A film was prepared in the same manner as in Comparative Example 2. This film was subjected to Al metallization and evaluation in the same manner as in Example 3. The wetting tension of the film was 40 dyne/cm.

According to the present invention, a polypropylene resin composition for metallized film, a film made thereof for metallization having an excellent adaptability to metallization and having no inferior effect to other materials contacting the film in respect to odor and taste and a metallized film prepared therefrom, are provided.

1. A polypropylene resin composition for a metallized film, which comprises 100 parts by weight of a polypropylene resin and 0.01 to 1 part by weight of a phosphate represented by the general formula (I): 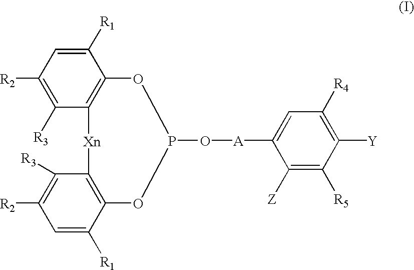
(wherein, R¹, R², R⁴ and R⁵ represent individually a hydrogen atom, alkyl group having 1 to 8 carbon atoms, cycloalkyl group having 5 to 8 carbon atoms, alkylcycloalkyl group having 6 to 12 carbon atoms, aralkyl group having 7 to 12 carbon atoms or phenyl group, respectively ; R³represents a hydrogen atom or alkyl group having 1 to 8 carbon atoms; X represents sulfur atom or a —CHR⁶— group (R⁶ represents hydrogen atom, an alkyl group having 1 to 8 carbon atoms or a cycloalkyl group having 5 to 8 carbon atoms); n is 0 or 1; A is an alkylene group with 2 to 8 carbon atoms or a *—CO(R⁷)ₘ— group (R⁷ is an alkylene group with 1 to 8 carbon atoms, * mark is indicative of the bonding site of A to oxygen atom and m is 0 or 1); and either one of Y or Z is a hydroxy group, alkoxy group having 1 to 8 carbon atoms, or an aralkyloxy group having 7 to 12 carbon atoms and the other is a hydrogen atom or alkyl group having 1 to 8 carbon atoms.)

2. The polypropylene resin composition according to claim 1, wherein the amount of the phosphite is 0.01 to 0.5 parts by weight.

3. A polypropylene resin composition film for metallization made of the polypropylene resin composition of claim 1.

4. The polypropylene resin composition film according to claim 3, wherein the polypropylene resin film is a polypropylene resin composition film for aluminum metallization.

5. A metallized polypropylene resin composition film obtained by depositing a metallic substance on the surface of the polypropylene resin composition film of claim 3.

6. The metallized polypropylene resin composition film according to claim 5, wherein the metallic substance is aluminum.
